(19) United States
(12) Patent Application Publication
(10) Pub. No.: US 2012/0266533 A1
(43) Pub. Date: Oct. 25, 2012

(54) Removable Plant Protection System and Method of Protecting a Plant

(75) Inventor: Petrus Mattheus Maria Hoff, Roosendaal (NL)

(73) Assignee: HOLDING P.M.M. HOFF B.V., Steenbergen (NL)

(21) Appl. No.: 13/395,190

(22) PCT Filed: Sep. 13, 2010
(86) PCT No.: PCT/NL2010/050581

§ 371 Date: May 11, 2012

(30) Foreign Application Priority Data
Sep. 11, 2009 (NL) 2003479

(51) Int. Cl. A01G 13/00

(52) U.S. Cl. 47/21.1; 47/30; 47/32.3

(57) ABSTRACT

The invention relates to a removable plant protection system, comprising a wall module including an upwardly extending wall segment that is arranged for throwing a shadow on a soil area near the wall module when the sun reaches its highest orbit point and for allowing a sun beam on the soil area at a time period on the day when the elevation of the sun is relatively low.

The invention relates to a removable plant protection system, comprising a wall module.

International patent publication WO 2009/078721 discloses a device for recovering moisture present in the atmosphere, the device being provided with a tube that is coupled to a water collection structure and that at least partly sideways surrounds a young plant that is placed in the collection structure.

When the device disclosed in WO '721 is employed in regions that are subjected to intense sun beams, the young plant may wither in response to the sun beams. On the other hand, if the tube is arranged such that sun beams can not reach the plant, growth of the plant might be very moderate.

It is an object of the invention to provide a removable plant protection system, comprising a wall module that admits merely sun beams having a moderate intensity. Thereto, the wall module includes an upwardly extending wall segment that is arranged for throwing a shadow on a soil area near the wall module when the sun reaches its highest orbit point and for allowing a sun beam on the soil area at a time period on the day when the elevation of the sun is relatively low, wherein the wall module includes two substantially planar wall segments between which the soil area is located, wherein the wall module at least partially surrounds the soil area, wherein the wall module has a substantially elongated form, and wherein the wall module is connected to a soil covering structure.

By removably providing an upwardly extending wall segment that provides a shadow when the sun beam strength is generally intense, at the sun's highest orbit point, and allows a sun beam when the sun beam strength is generally moderate, at a time period on the day when the elevation of the sun is relatively low, a plant can be protected against sun beams that are too intense, while less intense sun beams may reach the plant, thereby providing optimal light conditions for the plant.

Advantageously, the wall module at least partially surrounds the soil area, thereby providing an optimal protection for the plant.

According to an aspect of the invention, the wall module has a substantially elongated form, so that light might be admitted at sunrise and sunset when the longitudinal axis of the elongated soil form is oriented along an east-west line. However, when the sun reaches its highest orbit point, in the afternoon, the planar wall section reduces or entirely prohibits sun beams to reach the soil.

Further advantageous embodiments according to the invention are described in the following claims.

The invention also relates to a method of protecting a plant.

By way of example only, embodiments of the present invention will now be described with reference to the accompanying figures in which

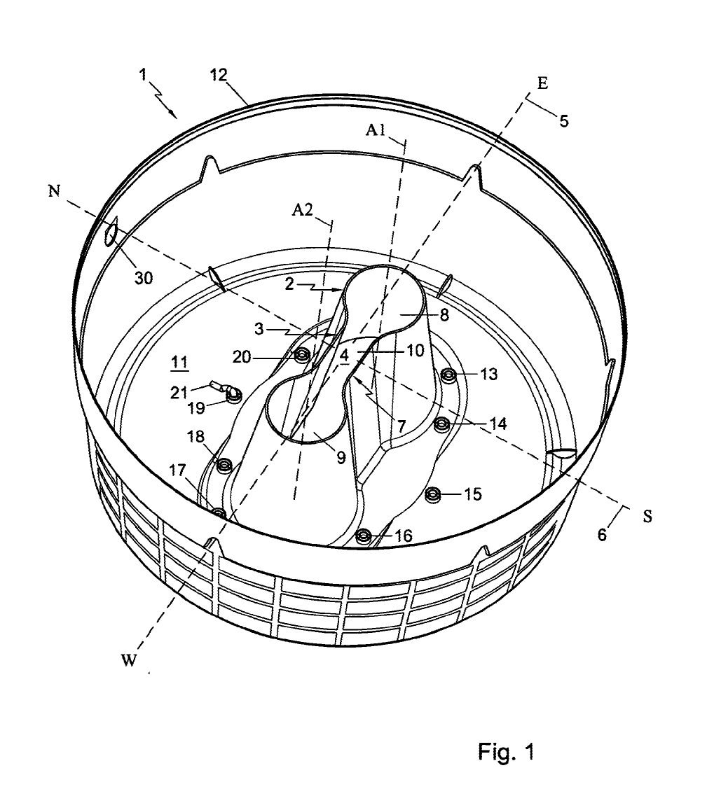

FIG. 1 shows a schematic perspective top view of a removable plant protection system according to the invention;

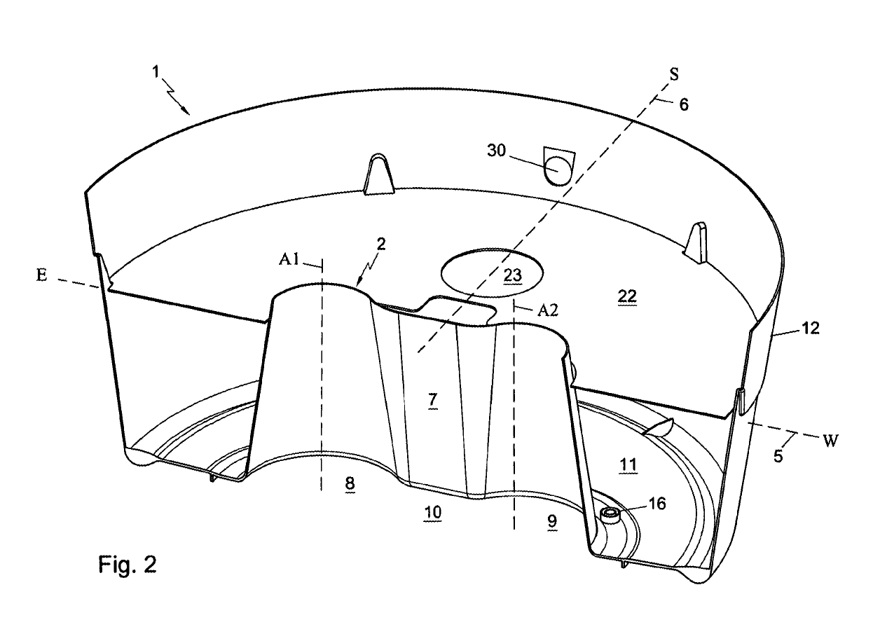

FIG. 2 shows a schematic perspective cross sectional view of the protection system shown in FIG. 1, further including a cover layer;

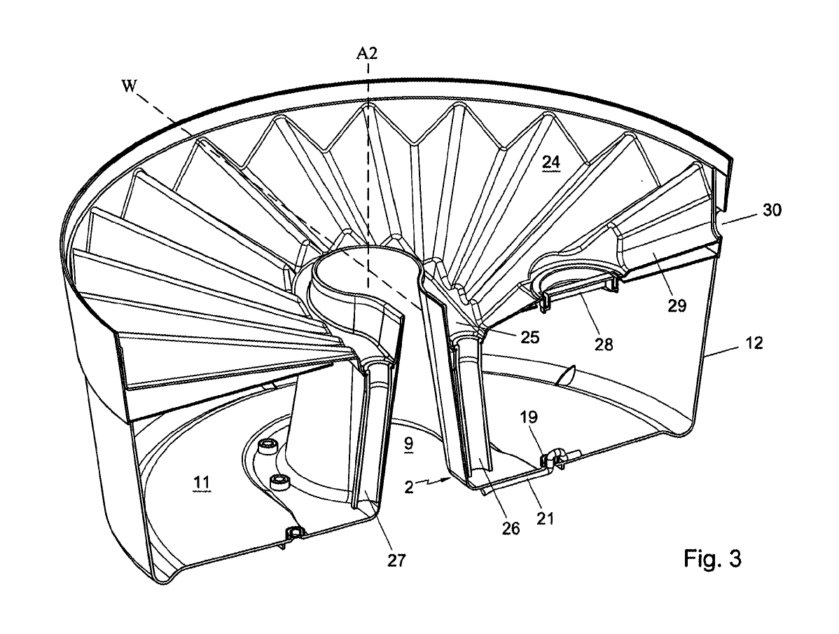

FIG. 3 shows a schematic perspective cross sectional view of the protection system shown in FIG. 2, further including a moisture receiving structure;

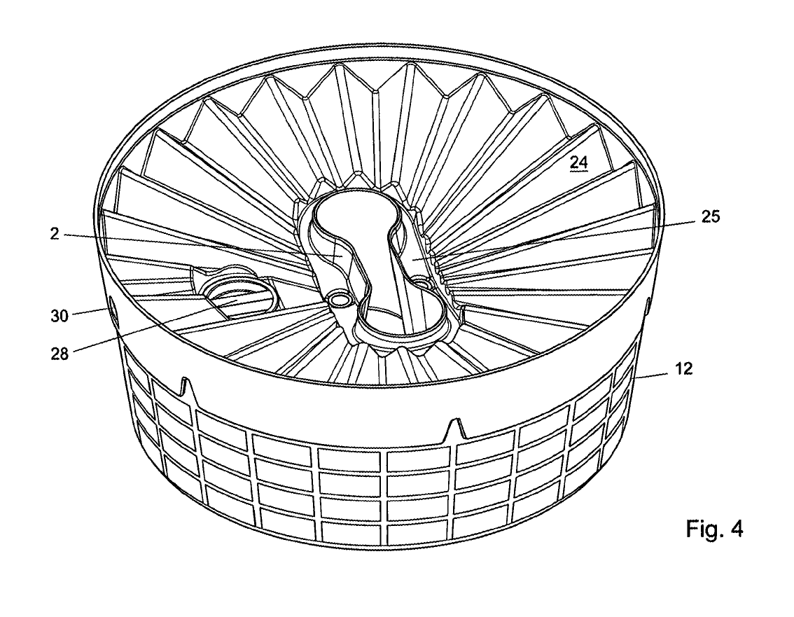

FIG. 4 shows a schematic perspective top view of the protection system shown in FIG. 3;

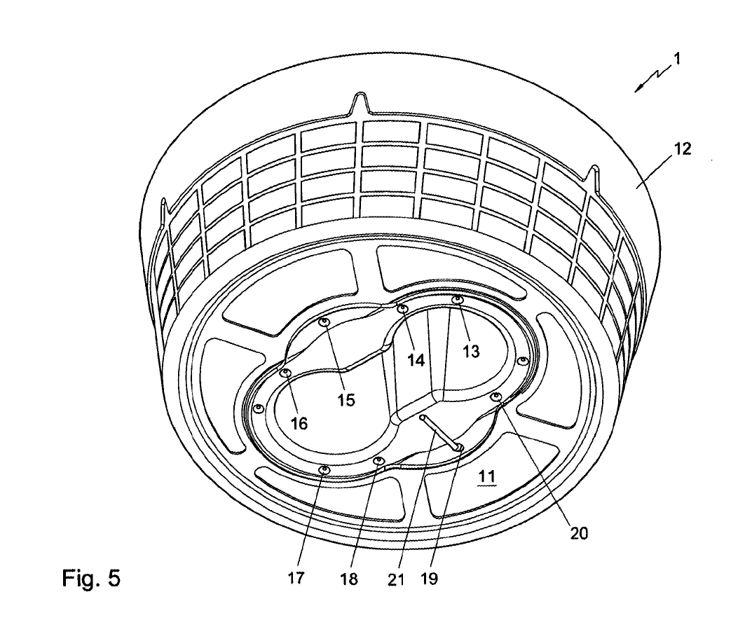

FIG. 5 shows a schematic perspective bottom view of the protection system shown in FIG. 1;

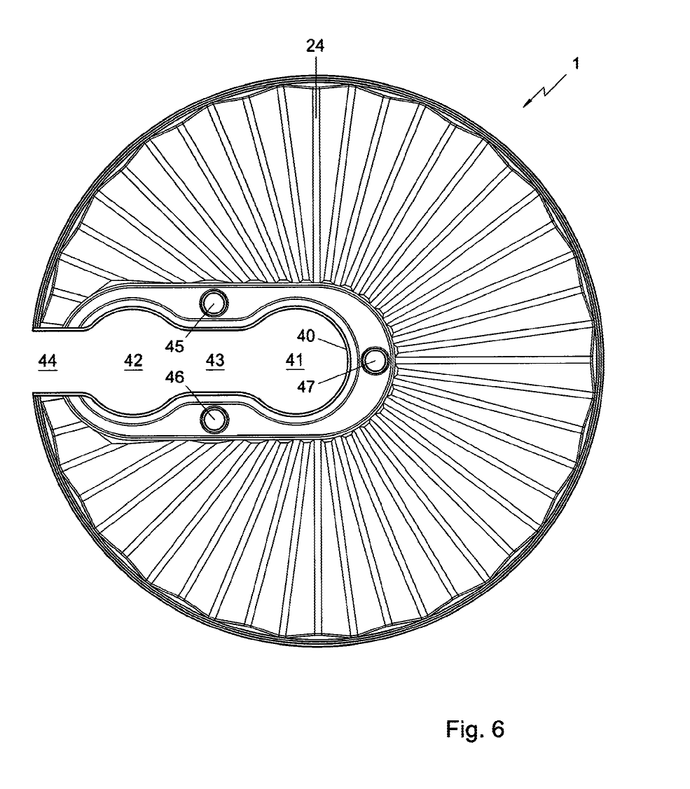

FIG. 6 shows a schematic top view of a further embodiment of a protection system according to the invention;

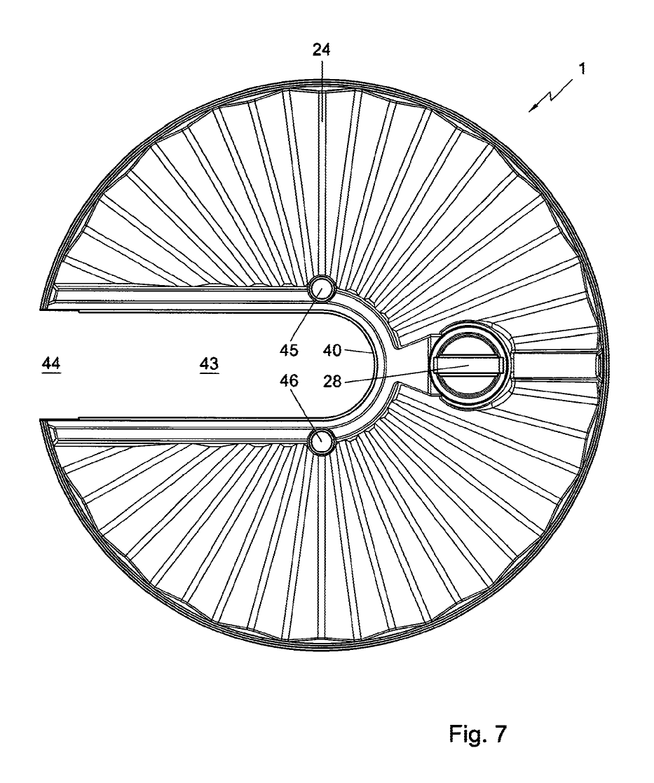

FIG. 7 shows a schematic top view of yet a further embodiment of a protection system according to the invention;

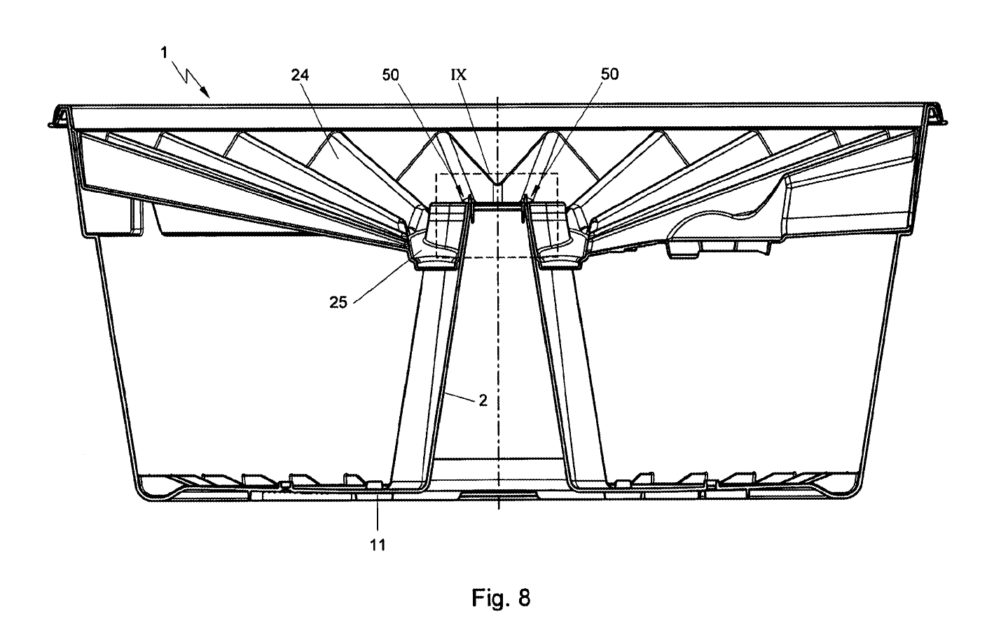

FIG. 8 shows a schematic cross sectional view of yet a further embodiment of a protection system according to the invention;

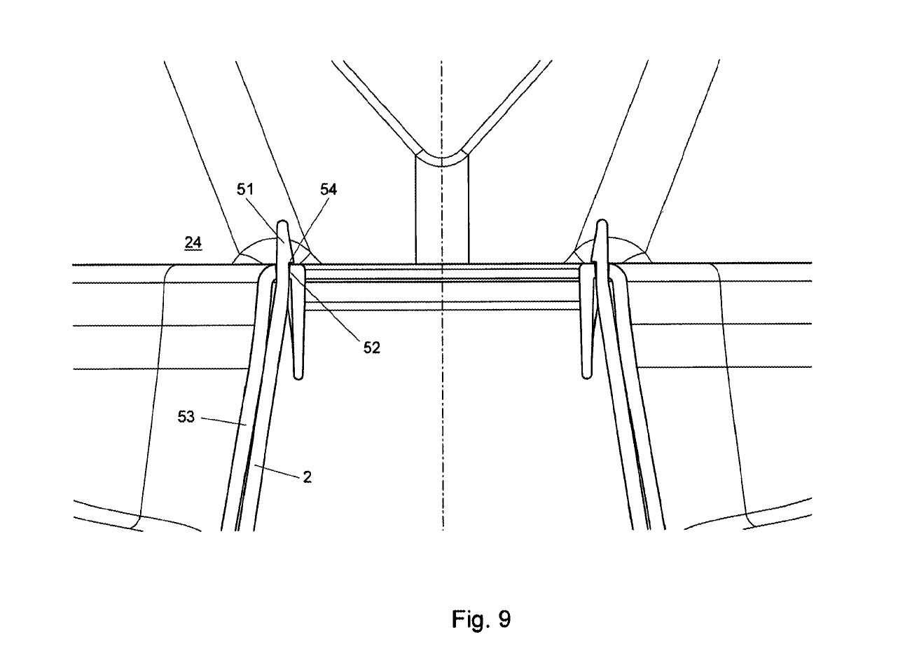

FIG. 9 shows a schematic detailed view of the schematic cross sectional view shown in FIG. 8; and

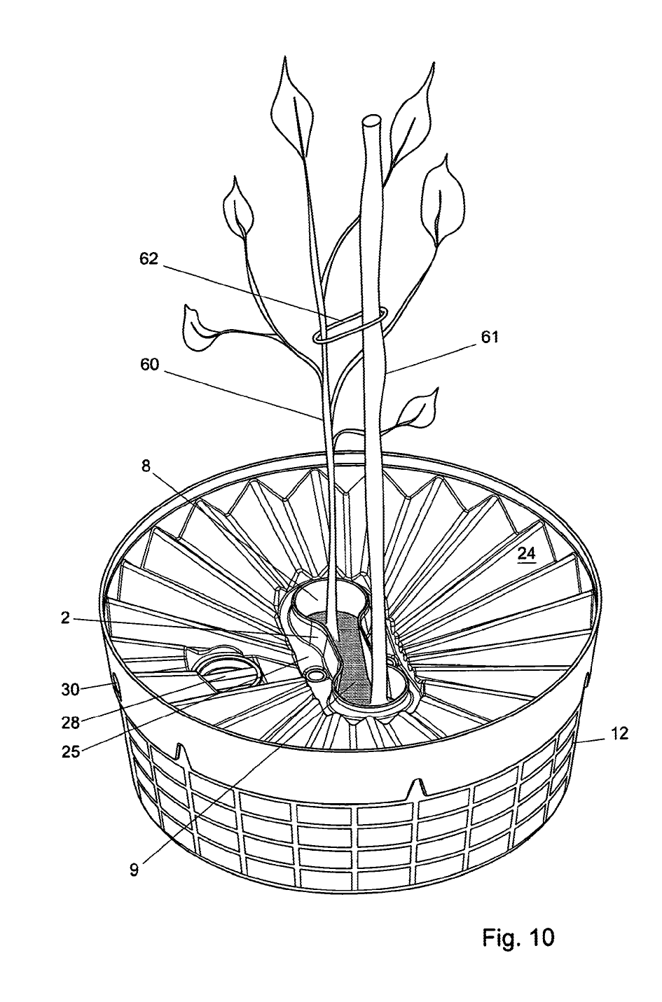

FIG. 10 shows a schematic perspective view of a protection system according to the invention including a plant.

It is noted that the figures show merely a preferred embodiment according to the invention. In the figures, the same reference numbers refer to equal or corresponding parts.

FIG. 1 shows a schematic perspective top view of a removable plant protection system 1 according to the invention. The system comprises an upwardly extending wall module 2 including a wall segment 3. During use of the removable plant protection system 1, one or a multiple number of seeds, plants or small trees are placed in a soil area 4 while the wall module 2 is arranged such that it on the one hand throws a shadow on the soil area 4 near the wall module 2 when the sun reaches its highest orbit point and on the other hand allows a sun beam on the soil area 4 at a time period on the day when the elevation of the sun is relatively low, e.g. a few hours after sunrise and/or a few hours before sunset.

Thereto, the system is placed on the Earth's surface and oriented such that the wall segment 3 extends substantially parallel to an Earth's circle of latitude, i.e. along an East-West line 5 extending from the East E to the West W. The East-West line 5 is perpendicular to a North-South line 6, also called a meridian line, extending from the North N to the South S.

After sunrise, when the sun beams have a direction substantially from the East E to the West W, along the East-West line 5, the wall module 2 allows sun light to access the soil area 4, thereby contributing to the growth of the one or multiple number of seeds, plants and/or small trees. A distance between the seeds, plants and/or small trees with respect to a wall location along the sun beams, is relatively large. Similarly, before sunset, when the sun beams have a direction substantially from the West W to the East E, along the East-West line 5, sun light may hit the soil area 4. In this respect it is noted that the direction of the sun beams are described here with their projected direction on the Earth's surface. In other words, the sun beam directions are described in terms of the Earth's wind direction scheme North, West, South and East, for sake of clarity neglecting the height component of the sun beam. During morning and evening hours the sun light strength is relatively low, so that damage to the seeds, plants and/or trees is counteracted. However, when the sun reaches its highest orbit point, the sun beam direction is along the North-South line 6, so that the wall module 2 casts a shadow on the soil area 4, thereby protection the seeds, plants and/or trees for a sun light intensity that might be too high. A distance between the seeds, plants and/or small trees with respect to a wall location along the sun beams, is now relatively small, so that the wall then has a shielding effect by providing a shadow area at the soil area 4 to be protected. When the plant protection system 1 is used in the Southern hemisphere, the shadow is cast to the South S, the situation as shown in FIG. 1. However, when the plant protection system 1 is applied in the Northern hemisphere, the shadow is cast to the North N. The system 1 according to the invention is particularly applicable in non-tropic zones where the sun in its highest orbit point has a non-perpendicular elevation.

The embodiment shown in FIG. 1 includes two substantially planar wall segments 3, 7 between which the soil area 4 is located so that a symmetric configuration is obtained. A user of the system 1 will adjust the orientation of the segments 3, 7 along the East West line 5 and has not to worry about the shadow side of the wall module 2, thereby avoiding that the soil area 4 is unintentially exposed to the sun during the whole day. In principle, however, a single upwardly extending wall segment can be applied. Further, the shown wall segments 3, 7 are substantially flat at a side facing the soil area 4. In other embodiments of the system according to the invention, other wall segment shapes are applied, e.g. a slightly curved wall segment at a side facing the soil area 4.

Advantageously, the wall module 2 entirely surrounds or encloses the soil area 4, thereby providing a simple, robust system that also mechanically protects the seeds, plants and/or young trees in the soil area 4. It is noted that the wall module 2 might, however, also be arranged to partially surround the soil area 4, e.g. to safe material in the manufacturing process.

By arranging the wall module 2 such that the at least partially surrounded soil area 4 has a substantially elongated form, light beams can be exploited in an optimal way, i.e. sun light is received when the sun intensity is relatively low while incidence of sun light having a relatively high intensity is counteracted. Moreover, by providing an elongated form, a multiple number of plants can be placed, e.g. two or three plants. Furthermore, the elongated form offers more space to plants, when the plant protection system 1 is lifted during the systems removal.

In the shown embodiment, the at least partially surrounded soil area 4 includes two mainly disc-shaped sections 8, 9 that are interconnected via a strip-shaped section 10 surrounded by the two substantially planar wall segments 3, 7, thus forming a bar-bell shaped area 4. As an example, a first plant is located in the first disc-shaped section 8, along a first vertical disc axis A1, while a second plant is located in the second disc-shaped section 9, along a second vertical disc axis A2. As another example, a first plant is located in the first disc-shaped section 8, while an elongated plant supporting element, e.g. a pole for supporting and/or guiding the plant, is located substantially vertically in the second disc-shaped section 9. Alternatively, the elongated plant supporting element can be placed in another section of the at least partially surrounded soil area, e.g. in the strip-shaped section 10. Obviously, also other geometries can be applied, e.g. rectangular shaped sections that are interconnected by a strip-shaped section. Further, the center line of the discs might substantially coincide with the width of the strip shaped section 10. As an alternative, the wall module encloses an elongated formed soil area.

The wall module 2 is mainly vertically oriented and upwardly tapered to provide a shadow on the soil area 4 when the sun is climbing to its highest orbit point. As an alternative, the wall module 2 is cylindrical being substantially invariant in horizontal cross sections. By tapering the wall module 2 such that at a lower region the surrounded area is larger than a surrounded area at a higher region, a relatively large volume is created for a plant in the soil area, thereby allowing the plant to grow both in upward and sideward directions. The plant may thus grow in a natural way providing optimal assimilation due to the relatively large volume and ventilation characteristics of the upwardly tapered wall module. Therefore, the growth of a relatively high and narrow shaped plant structure can be counteracted.

The removable plant protection system further comprises a soil covering structure 11 forming a bottom section of a water reservoir. Thereto, the bottom section 11 is attached to a radial outer wall section 12 to receive and hold water. The bottom section 11 is provided with a number of irrigation points 13-20 for irrigation the subsoil. The irrigation points may be connected to an injection needle or to a capillary structure 21 for irrigation the subsoil in a dosed manner. The wall module is attached to the covering structure 11 to form a radial inner wall section of the reservoir. The wall module 2 and the covering structure 11 as well as the radial outer wall section 12 can be formed integrally, or can be attached and sealed in a later stage during the manufacturing process. Instead of realizing a water reservoir, the wall module 2 and the covering structure 11 can be used for realizing a mechanically stable structure covering the soil surrounding the protected soil area.

FIG. 2 shows a schematic perspective cross sectional view of the protection system 1, further including a cover layer 22 that forms a top section of the water reservoir. The cover layer 22 is preferably formed as a separate element that is placed in the protection system 1. The cover layer 22 includes an aperture 23 providing an entrance to the water reservoir 1.

FIG. 3 shows a schematic perspective cross sectional view of the protection system 1, further including a moisture receiving structure 24 having a specific geometry for receiving rain, bloom and other moisture from the atmosphere. The water is collected in a drain 25 and flown to the reservoir via downwardly extending pipes 26, 27. The moisture receiving structure 24 further includes a cap 28 removably closing the aperture 23 in the cover layer 22, and an exit drain 29 flowing excess water to an exit opening 30 in the radial outer wall section 12 of the water reservoir. The wall module 2 extends through the cover layer 22 and the moisture receiving structure 24 and forms a radial inner wall of the drain 25. Also the moisture receiving structure 24 can be manufactured separately and attached to the plant protection system 1 in a modular way. Alternatively, the moisture receiving structure 24 or the cover layer 22 can form the radial inner wall of the drain 25.

FIG. 4 shows a schematic perspective top view of the protection system that is thus obtained in a modular way, preferably removably. Alternatively, the protection system can be manufactured as a number of separate elements that are fixedly mounted to each other.

FIG. 5 shows a schematic perspective bottom view of the protection system 1.

FIG. 6 shows a schematic top view of a further embodiment of a protection system 1 according to the invention. Here, the wall module 2 partially surrounds the soil area 4. In the shown embodiment, the wall module 2 is formed as a contour of a bar-bell shaped profile 40, surrounding two disc shaped areas 41, 42 interconnected by a strip-shaped section 43. The eccentrically located disc shaped area 42 is accessible from outside the protection system 1 via an entrance area 44. Since the growing area for the seeds, plants and/or plants is larger, the system 1 may remain in place for a longer time period without hindering the growing process of the plant(s). Further, the system may be removed by horizontally sliding the system such that the plants exit the system via the entrance area 44, as an alternative to removing the system vertically. When employing the horizontal removal approach, the chance that the plant(s) are damages, reduces considerably. The system also includes downwardly extending pipes 45, 46, 47 for flowing water towards the reservoir. In yet a further embodiment of a protection system 1 according to the invention, the wall module surrounds the soil area 4 in an even further reduced manner, e.g. by providing a wall module surrounding the soil area 4 over an angle range of circa 180°. This embodiment is a split version of the embodiment shown in FIG. 1 along the East-West line 5, thereby saving 50% of material and volume of the removable plant protection system. Obviously, other variants are also possible, e.g. a system including a wall module surrounding the soil area over an angle range of circa 270°.

FIG. 7 shows a schematic top view of yet a further embodiment of a protection system according to the invention. Here, the wall module 2 is formed as a U-shaped profile 40, surrounding a strip shaped area 43 that is accessible from outside the protection system 1 via the entrance area 44.

It is possible that during use of the plant protection system 1 the soil underneath the system beds down unevenly. Because of this, the covering structure 11 can bend, e.g. under the influence of the pressure of the water in the reservoir. Then, an opening may be formed between the wall module 2 on the one hand and the moisture receiving structure 24 and/or the cover layer 22 on the other hand. As a consequence, water may escape from the reservoir by evaporation.

FIG. 8 shows a schematic cross sectional view of yet a further embodiment of a protection system according to the invention. Here, in an advantageous embodiment of a protection system 1 of the invention, the wall module 2 is connected to the moisture receiving structure 24 by means of a, preferably releasable, connection means. The connection means include for example a single rigid connection element or a multiple number of rigid connection elements, such as one or more snap connection elements 50.

FIG. 9 shows a schematic detailed view of a detail IX shown in the schematic cross sectional view shown in FIG. 8. Here, the wall module 2 comprises joggles 51 with barbs 54. By attaching the moisture receiving structure 24 to the wall module 2, the joggles 51 reach trough holes 52 in the radial inner wall 53 of the drain 25. If during use the covering structure 11 bends downwardly, the barbs 54 prevent the joggles 51 to slip out of the holes 52. The barbs 54 form protruding end portions of the joggles 51 that counteract that the joggles unintentionally release from the corresponding holes 52. The protruding end portions extend substantially transversely with respect to the joggle's longitudinal orientation, e.g. in a direction transversely to the wall module 2 or in a direction parallel to the wall module 2. Apparently, the protruding end portions may extend in a multiple number of directions, e.g. by forming a cone shaped end portion of the joggle, such that a removal force has to be larger than an inserting force of the joggle. The connection elements thus include joggles 51 and holes 52 that cooperate forming a rigid connection. It is noted that the connection elements may also includes other cooperating elements for forming a connection, e.g. a screw extending through a hole. By providing mutually engaging elements a durable fixation can be obtained. Further, the connection can be formed otherwise, e.g. using glue material.

It is further noted that in the shown embodiment, the connection means are arranged for connecting the wall module 2 to the moisture receiving structure 24. Alternatively or additionally, the connection means are arranged for connecting the wall module 2 to the cover layer 22.

Optionally, the connection between the wall module 2 on the one hand, and the moisture receiving structure 24 and/or the cover layer 22 on the other hand is slidable, using a rail system, for guiding the wall module in a substantially vertical direction with respect to the cover layer 22 or the moisture receiving structure 24.

By providing the above-mentioned connection, it is counteracted that an opening is formed between the wall module 2 on the one hand, and the moisture receiving structure 24 and/or the cover layer 22 on the other hand. Then, undesired evaporation of water from the reservoir can be counteracted.

According to an aspect of the invention, other means can be provided counteracting that undesired openings are formed between the reservoir and the atmosphere. As an example, a single or a multiple number of stiff elements, like a prop or stay, extending between opposite portions of the wall module 2 can be applied in order to counteract that wall sections of the wall module 2 bend into a region above the surrounded soil area. As an another example, an intermediate flexible material, such as a flexible, water impermeable membrane, can be arranged, e.g. extending between the drain 25 and the wall module 2.

Preferably, the components of the reservoir including the wall module 2, the cover layer 22, and the moisture receiving structure 24 form modular elements that may be combined to form a box-shaped protection system 1 according to the invention. More preferably, the individual components are arranged such that they can be stored and transported in a compact manner, e.g. by nesting them. As an example, the moisture receiving structure 24 is formed such that is nestable. In this respect, by upwardly tapering the wall module, also the reservoir including the wall module 2 is nestable, thus providing a three element product having individual modular elements that can be stored and transported efficiently.

After the seeds, plants and/or trees have grown, the plant protection system 1 can be removed. The system is then available for a next protection cycle of new seeds, plants and/or trees. Alternatively, the system 1 is not removed.

In an advantageous manner, the system includes injection moulded product modules, thereby potentially reducing the cost price considerably.

FIG. 10 shows a schematic perspective view of a protection system 1 according to the invention, protecting a plant 60 extending through a first disc-shaped section 8. Further, a stake 61 extending through a second disc-shaped section 9 serves as a plant supporting element. A single or a multiple number of connection units 62, such as an iron wire, rope, elastic cord, connects the plant 60 to the plant supporting element. Optionally, the plant supporting element may be provided with a structure extending transverse with respect to the vertical direction.

The invention is not restricted to the embodiments described herein. It will be understood that many variants are possible.

Other such variants will be obvious for the person skilled in the art and are considered to lie within the scope of the invention as formulated in the following claims.

1. A removable plant protection system, comprising a wall module including an upwardly extending wall segment that is arranged for throwing a shadow on a soil area near the wall module when the sun reaches its highest orbit point and for allowing a sun beam on the soil area at a time period on the day when the elevation of the sun is relatively low,
wherein the wall module includes two substantially planar wall segments between which the soil area is located, wherein the wall module at least partially surrounds the soil area, wherein the wall module has a substantially elongated form, and wherein the wall module is connected to a soil covering structure.

2. The removable plant protection system according to claim 1, wherein the wall module includes two mainly disc-shaped sections that are interconnected via a strip-shaped section.

3. The removable plant protection system according to claim 1, wherein the wall module encloses the soil area.

4. The removable plant protection system according to claim 1, wherein the wall module is mainly vertically oriented.

5. The removable plant protection system according to claim 1, wherein the wall module is upwardly tapered.

6. The removable plant protection system according to claim 1, wherein the soil covering structure forms a bottom section of a water reservoir.

7. The removable plant protection system according to claim 6, wherein the water reservoir is provided with at least one irrigation point.

8. The removable plant protection system according to claim 6, further comprising a moisture receiving structure for collecting moisture that is present in the atmosphere and for flowing the received moisture towards the water reservoir.

9. The removable plant protection system according to claim 1, further including a cover layer that forms a top section of the water reservoir.

10. The removable plant protection system according to claim 6, wherein the wall module extends through at least one of the moisture receiving structure and/or the cover layer.

11. The removable plant protection system according to claim 1, further comprising connection means for connecting the wall module to at least one of the moisture receiving structure and the cover layer.

12. The removable plant protection system according to claim 1, wherein the system is box-shaped.

13. A method of protecting a plant, comprising the step of removably placing a wall module including an upwardly extending wall segment, near a soil area such that the wall segment throws a shadow on the soil area when the sun reaches its highest orbit point and that the wall segment allows sun beam on the soil area at at least one of sunrise and sunset.

14. The method of protecting a plant according to claim 13, wherein the wall module at least partially surrounds the soil area.

15. The method of protecting a plant according to claim 14, further comprising the step of placing an elongated plant supporting element in the at least partially surrounded soil area.
